(19) United States
(12) Patent Application Publication
(10) Pub. No.: US 2010/0121891 A1
(43) Pub. Date: May 13, 2010

(54) METHOD AND SYSTEM FOR USING PLAY LISTS FOR MULTIMEDIA CONTENT

(75) Inventor: Geoffrey R. Zampiello, Norwalk, CT (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/268,780

(22) Filed: Nov. 11, 2008

(51) Int. Cl. G06F 17/30

(52) U.S. Cl. 707/822; 707/E17.009

(57) ABSTRACT

A method and system for selecting multimedia content provided by a multimedia content delivery network (MCDN) are disclosed. A user may select multimedia programs from an electronic programming guide (EPG) to generate a play list defining the order of playback. The EPG may be provided by the MCDN and include scheduled programs for selection on the play list. The play list may be stored on a network server and is available for download from different types of playback devices, including mobile wireless and portable multimedia devices.

### BACKGROUND

1. Field of the Disclosure

The present disclosure relates to multimedia content delivery networks and, more particularly, using play lists for multimedia content.

2. Description of the Related Art

Subscribers to multimedia content delivery networks are provided with a user interface, including an electronic programming guide (EPG), for selecting multimedia content available for viewing. Operating the EPG often involves selecting a program for immediate viewing.

### BRIEF DESCRIPTION OF THE DRAWINGS

FIG. 1 is a block diagram of selected elements of an embodiment of a multimedia content delivery network;

FIG. 2 illustrates selected elements for accessing multimedia content;

FIG. 3 is a block diagram of selected elements of an embodiment of a multimedia content delivery network;

FIG. 4 is a block diagram of selected elements of an embodiment of a multimedia handling device;

FIG. 5 illustrates an embodiment of a method for selecting multimedia content; and

FIG. 6 illustrates a further embodiment of a method for selecting multimedia content.

### DESCRIPTION OF THE EMBODIMENT(S)

In one aspect, a disclosed method for selecting content provided by a multimedia content delivery network (MCDN) includes adding multimedia content for playback as items on a play list, wherein the order of items on the play list is the order of playback, and sending the play list to a network server for storage. The multimedia content from the MCDN may include scheduled programming accessible using an EPG. The method may further comprise storing the play list on a storage media at the network server. In some cases, the network server may include the MCDN, while the multimedia content may further include pay-per-view (PPV) programming.

In some embodiments, the method further includes retrieving the stored play list from the network server from a first multimedia playback device, and starting playback on the first multimedia device according to the play list. The method may then include stopping the playback on the first multimedia device, before restarting the playback on a second multimedia device according to the play list, wherein the playback is restarted from the previous stopping point of the play list. In some embodiments, the first multimedia device is a customer-premises equipment (CPE) device and the second multimedia device is a mobile wireless device configured for video playback.

In certain embodiments, the method further includes selecting one of a plurality of stored play lists from the network server, starting playback on a third multimedia device according to the selected play list, and from a fourth multimedia device, modifying the selected play list. The playback of multimedia content on the third multimedia device may be modified. The third multimedia device may be a computer system having access to the network server, while the fourth multimedia-capable device may be a wireless communication device. The computer system may access the network server via an Internet-protocol (IP) network. In some implementations, the play list is displayed on a display device.

In another aspect, a disclosed device, configured to select multimedia content provided by an MCDN, includes a processor, a network interface, and memory media accessible to the processor, including processor executable instructions. The instructions may be executable to receive information identifying a first plurality of multimedia programs for playback, from the MCDN, the information including the order of the playback, and store the information as a first play list in a collection of play lists. The instructions may further be executable to, in response to the first request, return information associated with the second play list, including information identifying a second plurality of multimedia programs for playback from the MCDN. The first and second plurality of multimedia programs may be scheduled programs on the MCDN and may be selected using an EPG provided by the MCDN.

In some embodiments, the device further includes instructions executable to initiate playback of the second play list, wherein multimedia programs according to the second play list are provided to a first playback device. The instructions may further be executable to receive a second request from the first playback device to transfer the playback of the second play list to a second playback device. In response to the second request, the instructions may be executable to terminate playback of the second play list on the first playback device, and initiate playback of the second play list on the second playback device. The playback on the second playback device may be initiated from the previous point of termination on the first playback device. In some cases, the first request is received from a third playback device. The first and second plurality of multimedia programs may be audio programs and/or video programs, such as video-on-demand (VOD) programs. The first and second plurality of multimedia programs may be PPV programs.

In yet another aspect, a disclosed computer-readable memory media includes program instructions for selecting multimedia content provided by an MCDN. The program instructions may be executable to enable the selection of a set of multimedia programs as a play list for playback according to a defined sequence, and store the play list on a network server.

In some cases, the set of multimedia programs may include scheduled programs on the MCDN. In some embodiments, the set of multimedia programs includes audio programs. The set of multimedia programs may be selected using an EPG provided by the MCDN. In some examples, the set of multimedia programs includes digital slideshow programs comprising a set of images.

In some embodiments, the program instructions are further executable to select a stored play list from the network server, and indicate playback of the selected play list on a first multimedia-capable device. The instructions may further be executable to receive, via the MCDN, the set of multimedia programs according to the selected play list on the first multimedia-capable device, and playback of the received multimedia programs on the first multimedia-capable device. The instructions may still further be executable to interrupt the playback of the selected play list on the first multimedia-capable device, and resume the playback of the selected play list on a second multimedia-capable device. The playback may be resumed from the point of interruption on the first multimedia-capable device. The first multimedia-capable device may be a CPE device, while the second multimedia-capable device may be a wireless communication device.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

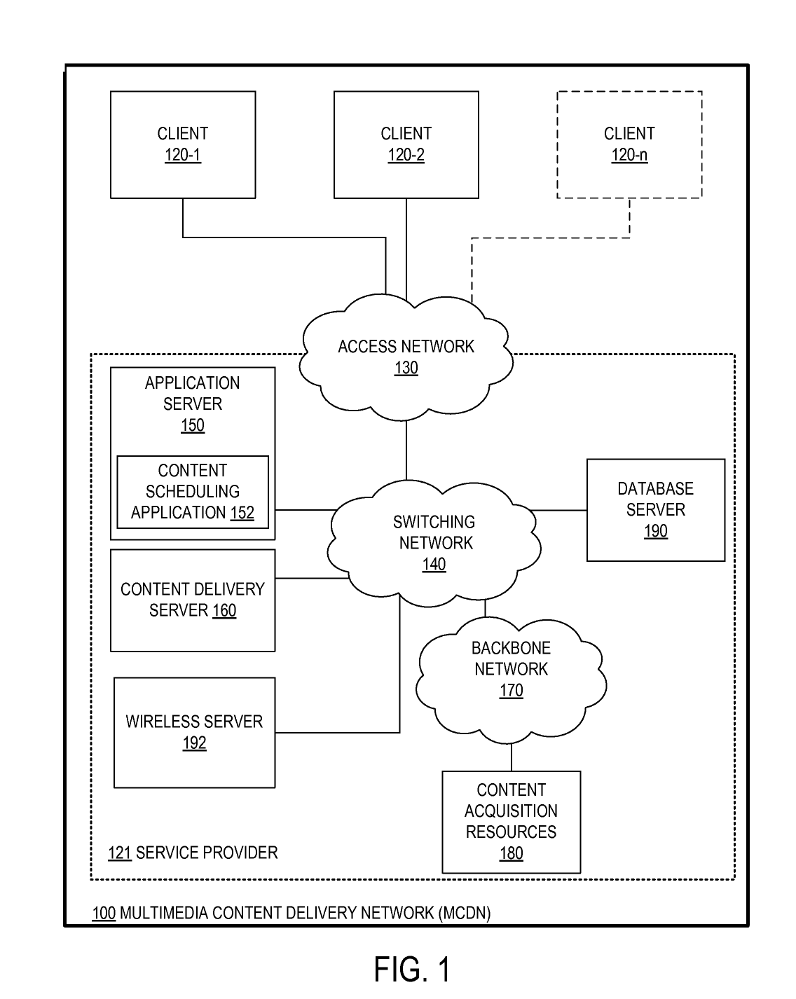

Turning now to the drawings, FIG. 1 is a block diagram illustrating selected elements of an embodiment of an MCDN 100. Although multimedia content is not limited to TV, VOD, or PPV programs, the depicted embodiments of MCDN 100 and its capabilities are primarily described herein with reference to these types of multimedia content, which are interchangeably referred to herein as multimedia content, multimedia content program(s), multimedia programs or, simply, programs or content.

The elements of MCDN 100 illustrated in FIG. 1 depict network embodiments with functionality for delivering multimedia content to a set of one or more subscribers. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120 and a service provider 121. Each client 120 may represent a different subscriber of MCDN 100. In FIG. 1, a plurality of n clients 120 is depicted as client 120-1, client 120-2 to client 120-n, where n may be a large number. Service provider 121 as depicted in FIG. 1 encompasses resources to acquire, process, and deliver programs to clients 120 via access network 130. Such elements in FIG. 1 of service provider 121 include content acquisition resources 180 connected to switching network 140 via backbone network 170, as well as application server 150, database server 190, wireless server 192, and content delivery server 160, also shown connected to switching network 140.

Access network 130 demarcates clients 120 and service provider 121, and provides connection path(s) between clients 120 and service provider 121. In some embodiments, access network 130 is an IP compliant network. In some embodiments, access network 130 is, at least in part, a coaxial cable network. It is noted that in some embodiments of MCDN 100, access network 130 is owned and/or operated by service provider 121. In other embodiments, a third part may own and/or operate at least a portion of access network 130.

In IP-compliant embodiments of access network 130, access network 130 may include a physical layer of unshielded twist pair cables, fiber optic cables, or a combination thereof. MCDN 100 may include digital subscribe line (DSL) compliant twisted pair connections between clients 120 and a node (not depicted) in access network 130 while fiber, cable or another broadband medium connects service provider resources to the node. In other embodiments, the broadband cable may extend all the way to clients 120.

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL compliant connections, switching network 140 may include elements of a DSL Access Multiplexer (DSLAM) that multiplexes many subscriber DSLs to backbone network 170.

In FIG. 1, backbone network 170 represents a private network including, as an example, a fiber based network to accommodate high data transfer rates. Content acquisition resources 180 as depicted in FIG. 1 encompass the acquisition of various types of content including broadcast content, other “live” content including national content feeds, and VOD content.

Thus, the content provided by service provider 121 encompasses multimedia content that is scheduled in advance for viewing by clients 120 via access network 130. Such multimedia content, also referred to herein as “scheduled programming,” may be selected using an EPG, as will be described in detail below. Accordingly, a user of MCDN 100 may be able to browse scheduled programming well in advance of the broadcast date and time, and may decide to select programs in advance of a viewing session. Some scheduled programs may be “regularly” scheduled programs, which recur at regular intervals or at the same periodic date and time (i.e., daily, weekly, monthly, etc.). A “play list,” as used herein, refers to a set of multimedia programs, including scheduled programming, and defines the order in which the multimedia programs are played back.

Acquired content is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of MCDN 100 may include content acquisition resources in regional offices that are connected to switching network 140.

Although service provider 121 is depicted in FIG. 1 as having switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 also illustrates application server 150 connected to switching network 140. As suggested by its name, application server 150 may host or otherwise implement one or more applications for multimedia content delivery network 100. Application server 150 may be any data processing system with associated software that provides applications for clients or users. Application server 150 may provide services including multimedia content services, e.g., EPG, digital video recording (DVR), VOD, or PPV programs, internet protocol television (IPTV) portal, digital rights management (DRM) servers, navigation/middleware servers, conditional access systems (CAS), and remote diagnostics, as examples.

Applications provided by application server 150 may be downloaded and hosted on other network resources including, for example, content delivery server 160, switching network 140, and/or on clients 120. Application server 150 is configured with a processor and storage media (not shown in FIG. 1) and is enabled to execute processor instructions, such as those included within a software application. As depicted in FIG. 1, application server 150 may be configured to include content scheduling application 152, which, as will be described in detail below, is enabled to select multimedia content provided to client 120 of MCDN 100.

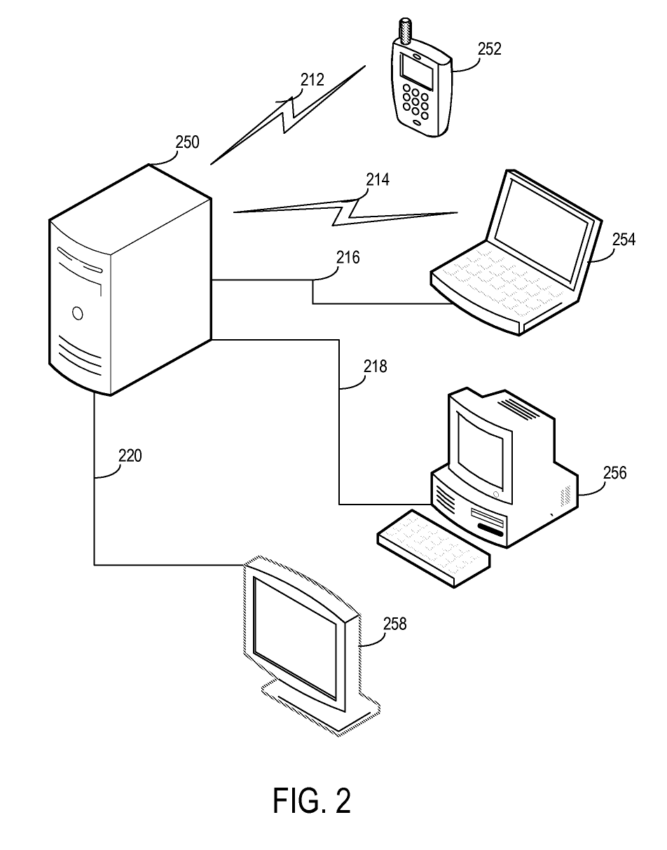

Additionally shown in FIG. 1 is wireless server 192, which provides access to MCDN 100 for wireless networks (not shown in FIG. 1) via switching network 140. Wireless server 192 may support any number of external networks and standards, for example, the Global System for Mobile Communications (GSM) networks, Code division multiple access (CDMA) networks, etc. Wireless server 192 may specifically support certain feature sets of wireless network standards, such as text messaging, email, instant messaging, etc. In one embodiment, wireless server 192 supports Short Message Service (SMS) communications. In particular, wireless server 192 may route commands and messages to/from content scheduling application 152 from a variety of wireless devices and networks, as will be described in detail below (see also FIG. 2).

For users of MCDN 100, represented by clients 120 in FIG. 1, wireless server 192 provides a communication gateway for executing commands and receiving information related to MCDN 100. In certain embodiments, service provider 121 itself offers wireless communication services using wireless server 192, and also may provide users with wireless devices. In some embodiments, users may access MCDN 100 via wireless network 192 using their own individual wireless devices, for which wireless service is provided by an entity other than service provider 121. It is noted that access to MCDN 100 via wireless network 192 may be facilitated in some cases using network addresses or numbers that are publicly available. In some embodiments, wireless server 192 is configured to disambiguate communications from wireless devices and so identify, authenticate, or authorize specific clients 120 for accessing MCDN 100.

Further depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In some embodiments, database server 190 includes a data warehousing application, accessible via switching network 140, that can be used to record and access structured data, such as user information for selecting multimedia content and generating play lists, as will be discussed in detail below.

Referring now to FIG. 2, selected elements for accessing multimedia content are illustrated. In FIG. 2, server 250 represents a generalized “server” for processing user information for selecting multimedia content and generating play lists. In some embodiments, server 250 represents functionality represented in FIG. 1 by application server 150, wireless server 192, and/or database server 190, working alone, or in combination. Accordingly, server 250 is configured to provide access to content scheduling application 152 via one or more network connections described below.

Wireless communication device 252 may access server 250 using wireless signal 212. In one embodiment, device 252 includes a cellular telephone, and provides extended functionality, such as wireless Internet access, email, text messaging, etc. In some cases, device 252 comprises a processor and memory media, including processor executable instructions.

Mobile computing device 254 is shown in FIG. 2 accessing server 250 via wireless signal 214. In some embodiments, device 254 is a portable computer and wireless signal 214 is a wireless communications network, such as IEEE 802.11, also known as WiFi. In some cases, wireless signal 214 is a network such as IEEE 802.16, also known as WiMAX. It is noted that device 254 may also access server 250 using a fixed network connection, represented by link 216, which may be a galvanic or optical network connection.

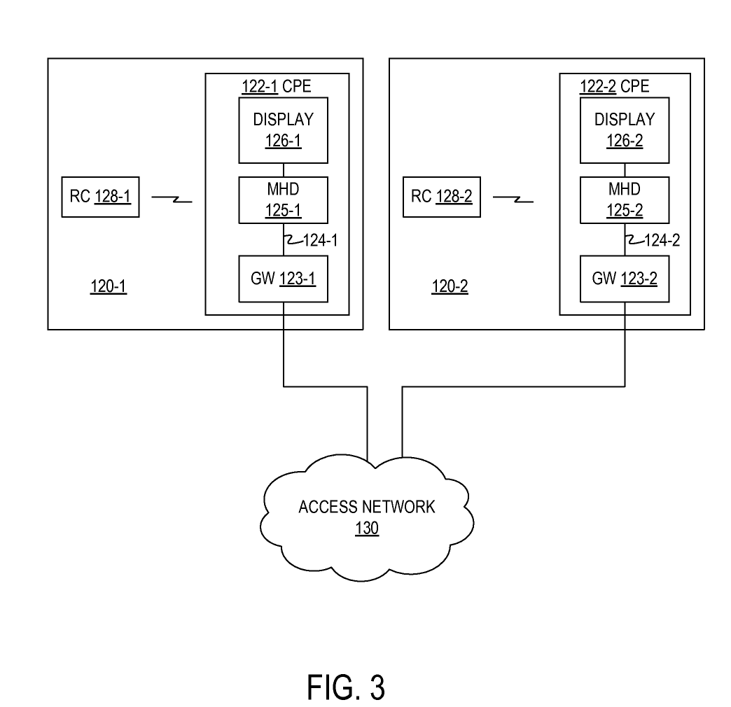

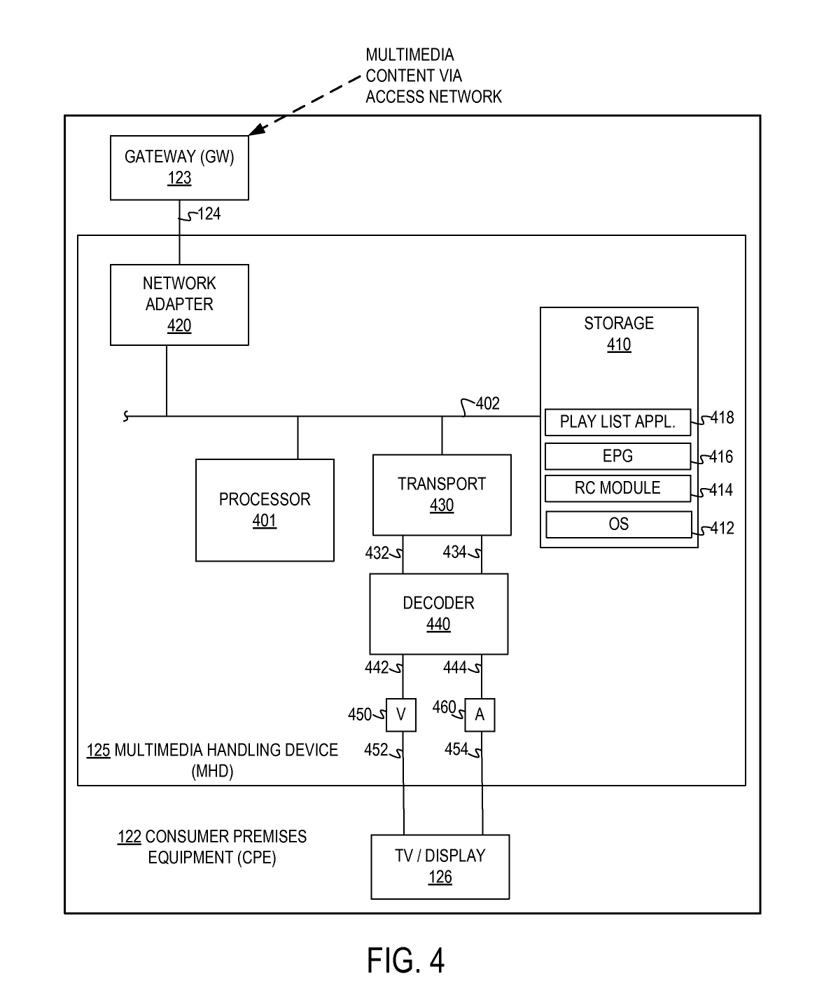

Fixed computing device 256, as depicted in FIG. 2, may access server 250 via fixed network connection 218, similar to link 216 discussed above. In some embodiments, device 256 may also employ a wireless network, for at least a portion of the connection to server 250 (not shown in FIG. 2). In some instances, device 256 is a personal computer and link 218 is an Internet, or an IP, network connection. Finally, a multimedia display device 258 is shown accessing server 250 via link 220. In some embodiments, device 258 is a television apparatus, with expanded network functionality. In some cases, device 258 represents hardware at client 120, such as CPE 122 (see FIGS. 3 and 4). As noted above, link 220 may be similar to links 218 and 216. In some embodiments, link 220 represents an access network, such as access network 130 shown in FIG. 1.

Thus, in FIG. 2, a user may employ a variety of wired and/or wireless devices to access server 250 for selecting multimedia content for playback. In certain embodiments, an instant messaging environment on computer 254 or 256, cellular telephone 252, multimedia display device 258, or other personal wireless device (personal data assistant (PDA), smart phone, etc.) is used to access multimedia content. As will be described in detail below, the user may store, retrieve, and play back a play list for multimedia content by accessing content scheduling application 152 via server 250.

Turning now to FIG. 3, clients 120 are shown in additional detail with respect to access network 130. Clients 120 may include network appliances collectively referred to herein as CPE 122. In the depicted embodiment, CPE 122 includes the following devices: gateway (GW) 123, multimedia handling device (MHD) 125, and display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate device.

In FIG. 3, GW 123 provides connectivity for client 120 to access network 130. GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof. GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 3 further include a display device or, more simply, a display 126. Display 126 may be implemented as a TV, a liquid crystal display screen, a computer monitor, or the like. Display 126 may comply with a display standard such as National Television System Committee (NTSC), Phase Alternating Line (PAL), or another suitable standard. Display 126 may include one or more speakers (integrated or external) to play audio content.

Clients 120 are further shown with their respective remote control device (RC) 128, which is configured to control the operation of MHD 125 by means of a user interface (not shown in FIG. 2) displayed on display 126. RC 128 of client 120 is operable to communicate requests or commands wirelessly to MHD 125 using infrared (IR) or radio frequency (RF) signals. MHDs 125 may also receive requests or commands via buttons (not depicted) located on side panels of MHDs 125.

MHD 125 is enabled and configured to process incoming multimedia signals to produce audio and visual signals suitable for delivery to display 126 and any optional external speakers (not depicted). Incoming multimedia signals received by MHD 125 may be compressed and/or encrypted, digital or analog, packetized for delivery over packet switched embodiments of access network 130 or modulated for delivery over cable-based access networks. In some embodiments, MHD 125 may be implemented as a stand-alone set top box suitable for use in a co-axial or IP-based MCDN.

Referring now to FIG. 4, a block diagram illustrating selected elements of an embodiment of MHD 125 is presented. In FIG. 3, MHD 125 is shown as a functional component of CPE 122 along with GW 123 and display 126, independent of any physical implementation, as discussed above with respect to FIG. 3.

In the embodiment depicted in FIG. 4, MHD 125 includes processor 401 coupled via shared bus 402 to storage media collectively identified as storage 410. MHD 125, as depicted in FIG. 4, further includes network adapter 420 that interfaces MHD 125 to LAN 124 and through which MHD 125 receives multimedia content.

In embodiments suitable for use in IP based content delivery networks, MHD 125, as depicted in FIG. 4, may include transport unit 430 that assembles the payloads from a sequence or set of network packets into a stream of multimedia content. In coaxial based access networks, content may be delivered as a stream that is not packet based and it may not be necessary in these embodiments to include transport unit 430. In a co-axial implementation, however, clients 120 may require tuning resources (not explicitly depicted in FIG. 4) to “filter” desired content from other content that is delivered over the coaxial medium simultaneously and these tuners may be provided in MHDs 125. The stream of multimedia content received by transport unit 430 may include audio information and video information and transport unit 430 may parse or segregate the two to generate video stream 432 and audio stream 434 as shown.

Video and audio streams 432 and 434, as output from transport unit 430, may include audio or video information that is compressed, encrypted, or both. A decoder unit 440 is shown as receiving video and audio streams 432 and 434 and generating native format video and audio streams 442 and 444. Decoder 440 may employ any of various widely distributed video decoding algorithms including any of the Motion Pictures Expert Group (MPEG) standards or Windows Media Video (WMV) standards including WMV 9 which has been standardized as Video Codec-1 (VC-1) by the Society of Motion Picture and Television Engineers. Similarly decoder 440 may employ any of various audio decoding algorithms including Dolby® Digital, Digital Theatre System (DTS) Coherent Acoustics, and Windows Media Audio (WMA).

The native format video and audio streams 442 and 444 as shown in FIG. 4 may be processed by encoders/digital-to-analog converters (encoders/DACs) 450 and 460 respectively to produce analog video and audio signals 452 and 454 in a format compliant with display 126, which itself may not be a part of MHD 125. Display 126 may comply with NTSC, PAL or any other suitable television standard.

Storage 410 encompasses persistent and volatile media, fixed and removable media, and magnetic and semiconductor media. Storage 410 is operable to store instructions, data, or both. Storage 410 as shown includes sets or sequences of instructions, namely, an operating system 412, a remote control application program identified as RC module 414, EPG 416, and a play list application 418. Operating system 412 may be a UNIX or UNIX-like operating system, a Windows® family operating system, or another suitable operating system. In some embodiments, storage 410 is configured to store and execute instructions provided as services to client 120 by application server 150, as mentioned previously.

EPG 416 represents a guide to the multimedia content provided to client 120 via MCDN 100, and may be shown to the user as an element of the user interface. The user interface may include a plurality of menu items arranged according to one or more menu layouts, which enable a user to operate MHD 125. The user may operate the user interface, including EPG 416, using RC 128 (see FIG. 3) in conjunction with RC module 414. In some embodiments, content scheduling application 152, in conjunction with EPG 416 and play list application 418, provide functionality to generate, modify, access or retrieve play lists, as well as play back multimedia programs on a multimedia-capable device according to selected play lists.

It is further noted that in embodiments employing a wireless communications device, or other portable multimedia-capable device, such a wireless or portable device may be configured to execute play list application 418. In such portable or wireless embodiments, play list application 418 may communicate with content scheduling application 152 via wireless server 192 to provide multimedia content scheduling according to the methods described herein.

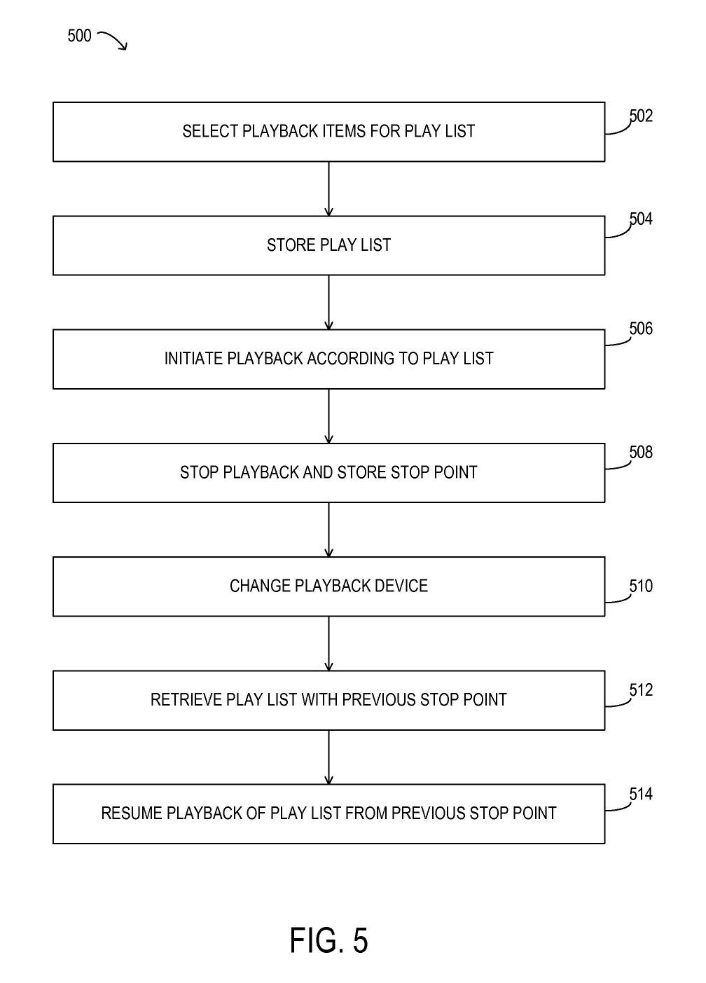

Referring now to FIG. 5, one embodiment of a method 500 for selecting multimedia content provided by MCDN 100 is depicted. Accordingly, method 500 may be executed in a continuous or intermittent manner across a large number of clients 120. It is noted that content scheduling application 152, alone or in combination with play list application 418, may be configured to execute method 500. It is further noted that the operations depicted in FIG. 5 may be rearranged, duplicated, or omitted in various embodiments of method 500.

In FIG. 5, a user may select desired multimedia content (i.e., multimedia programs) as items for playback according to a play list, also referred to as “populating” the play list (operation 502). The play list includes the order of playback of the selected items. The selected items may include regularly scheduled programming that appears in EPG 416 (see FIG. 4). Some examples of multimedia programs that may be selected as items on a play list include video programs, audio programs, slideshows (images) and include content such as television, cinema movies, cartoons, photographs, digital renderings, music, concerts, artistic renderings, etc. In some embodiments, a user may embed previously stored play lists as an item in a play list.

After populating the play list, the play list may be stored (operation 504). In one embodiment, the play list may be stored on a network server for access via different network mediums and devices (see FIG. 2). In some embodiments, content scheduling application 152 stores the play list on database server 190. In other embodiments, play list application 418 may store the play list locally on a portable or wireless device, prior to uploading via wireless server 192. After storage on a network server, such as database server 190, a desired play list may be accessed by the user using any of the devices 252, 254, 256, and/or 258, as depicted in FIG. 2.

The user may then choose to initiate playback of the play list (operation 506) on a first multimedia-capable device. The multimedia content on the play list may be played back using numerous types of multimedia-capable device, such as any of the devices 252, 254, 256, and/or 258, depicted in FIG. 2. After playback has been initiated, the user may stop playback according to the play list on the first device, whereby the stop point with respect to the play list and the current multimedia program is stored (operation 508). In some embodiments, the stop point is stored on a network server, such as database server 190.

While the play list is stopped, the user may choose to change the multimedia-capable playback device (operation 510). For example, the user may begin viewing a play list on a first fixed multimedia-capable device, such as device 258, and change to a second portable device, such as device 252 (see FIG. 2). After changing to the second device for playback, the user may retrieve the play list along with the previous stop point (operation 512). Then, the user may select to resume playback on the second device (operation 514). In some embodiments, the user may select the stop point, or another point on the play list, such as the beginning of a multimedia program or another item on the play list, for resuming playback on the second device. It is noted that the functionality described in method 500 may be repeated with additional multimedia-capable devices as desired.

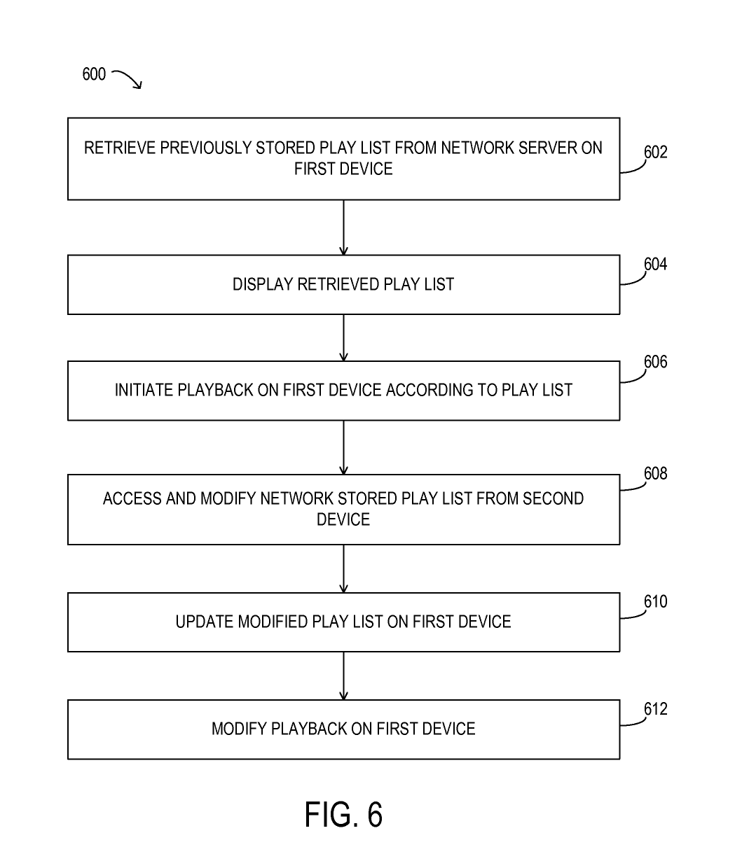

Referring now to FIG. 6, one embodiment of a method 600 for selecting multimedia content provided by MCDN 100 is depicted. It is noted that operations 602-612 are exemplary, and may be repeated or omitted in a given implementation of method 600. A user may retrieve a previously stored play list from a network server on a first multimedia-capable device (operation 602). The play list may be displayed on the first device (operation 604). The user may then choose to initiate playback on the first device according to the retrieved play list (operation 606).

While the first device is playing back the play list, the user (or another authorized user) may choose to access and modify the play list using a second device (operation 608). The second device may be at a different location than the first device. In some embodiments, operation 608 is performed prior to operation 606. In some embodiments, the modifications to the play list in operation 608 include adding items, deleting items, rearranging the playback order, modifying stop points, deleting stop points, etc. In some embodiments, the play list is accessed from database server 190 in operations 602 and 608. The play list may then be updated on the first device, according to the changes performed by the second device (operations 610). In some embodiments, the play list is updated on the first device automatically in operation 610, without any additional user action after operation 608 is performed. Then, the playback of the play list is modified on the first device (operation 612). In some embodiments, the modification of the play list in operation 612 takes effect immediately. In other embodiments, the user at the first device may override the modification for the current playback in progress. In some cases, the modified playback is initiated once the current item being played back from operation 606 has completed. Other arrangements for the functionality provided herein are also contemplated.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for designating presentation of multimedia content provided by a multimedia content delivery network (MCDN), comprising:
adding multimedia content as items on a play list, wherein the order of items on the play list is the order of presentation; and
sending the play list to a network server for storage;
wherein the designation of the multimedia content includes accessing scheduled programming information using an electronic programming guide.

2. The method of claim 1, further comprising:
storing the play list on a storage media at the network server.

3. The method of claim 1, wherein the network server is included in the MCDN, and wherein the multimedia content further includes pay-per-view programming.

4. The method of claim 1, further comprising:
retrieving the stored play list from the network server from a first multimedia playback device; and
starting presentation on the first multimedia device according to the play list.

5. The method of claim 4, further comprising:
stopping the presentation on the first multimedia device; and
restarting the presentation on a second multimedia device according to the play list, wherein the presentation is restarted from the previous stopping point of the play list.

6. The method of claim 5, wherein the first multimedia device is a customer-premises equipment device and wherein the second multimedia device is a mobile wireless device configured for video playback.

7. The method of claim 5, further comprising:
selecting one of a plurality of stored play lists from the network server;
starting presentation on a third multimedia device according to the selected play list; and
from a fourth multimedia device, modifying the selected play list, wherein presentation of multimedia content on the third multimedia device is modified.

8. The method of claim 7, wherein the third multimedia device is a computer system having access to the network server and wherein the fourth multimedia-capable device is a wireless communication device.

9. The method of claim 8, wherein the computer system accesses the network server via an Internet-protocol network.

10. The method of claim 1, further comprising:
displaying the play list on a display device.

11. A device, configured to select multimedia content provided by a multimedia content delivery network (MCDN), comprising:
a processor;
a network adapter for receiving the multimedia content; and
memory media accessible to the processor, including processor executable instructions to:
receive information identifying a first plurality of multimedia programs for playback, from the MCDN, the information including the order of the playback;
store the information as a first play list in a collection of play lists;
receive a first request for a second play list stored in the collection of play lists; and
in response to the first request, return information associated with the second play list, including information identifying a second plurality of multimedia programs for playback from the MCDN,
wherein the first and second plurality of multimedia programs are scheduled programs on the MCDN and are selectable using an electronic programming guide provided by the MCDN.

12. The device of claim 11, further comprising instructions executable to:
initiate playback of the second play list, wherein multimedia programs according to the second play list are provided to a first playback device.

13. The device of claim 12, further comprising instructions executable to:
receive a second request from the first playback device to transfer the playback of the second play list to a second playback device; and
in response to the second request:
terminate playback of the second play list on the first playback device; and
initiate playback of the second play list on the second playback device, wherein the playback on the second playback device is initiated from the previous point of termination on the first playback device.

14. The device of claim 13, wherein the first request is received from a third playback device.

15. The device of claim 11, wherein the first and second plurality of multimedia programs are audio programs.

16. The device of claim 11, wherein the first and second plurality of multimedia programs are video programs.

17. The device of claim 16, wherein the first and second plurality of multimedia programs include video-on-demand programs.

18. The device of claim 11, wherein the first and second plurality of multimedia programs include pay-per-view programs.

19. Computer-readable memory media, including program instructions for selecting multimedia content provided by a multimedia content delivery network (MCDN), said program instructions executable to:
enable the selection of a set of multimedia programs as a play list for playback according to a defined sequence; and
store the play list on a network server,
wherein the set of multimedia programs includes scheduled programs on the MCDN.

20. The memory media of claim 19, wherein the set of multimedia programs includes video-on-demand programs and/or pay-per-view video programs.

21. The memory media of claim 19, wherein the set of multimedia programs includes audio programs.

22. The memory media of claim 19, wherein the set of multimedia programs is selectable using an electronic programming guide provided by the MCDN.

23. The memory media of claim 19, further comprising program instructions executable to:
select a stored play list from the network server;
indicate playback of the selected play list on a first multimedia-capable device;
receive, via the MCDN, the set of multimedia programs according to the selected play list on the first multimedia-capable device; and
playback the received multimedia programs on the first multimedia-capable device.

24. The memory media of claim 23, further comprising program instructions executable to:
interrupt the playback of the selected play list on the first multimedia-capable device; and
resume the playback of the selected play list on a second multimedia-capable device,
wherein the playback is resumed from the point of interruption on the first multimedia-capable device.

25. The memory media of claim 23, wherein the first multimedia-capable device is a customer premises equipment device and wherein the second multimedia-capable device is a wireless communication device.

26. The memory media of claim 19, wherein the set of multimedia programs includes digital slideshow programs comprising a set of images.
